(19) United States
(12) Patent Application Publication
(10) Pub. No.: US 2010/0306797 A1
(43) Pub. Date: Dec. 2, 2010

(54) SYSTEMS AND METHODS FOR A NATIONAL EMERGENCY ALERT TEST MESSAGE

(75) Inventor: Martin Curran, Cheyenne, WY (US)

Correspondence Address: Black Lowe & Graham PLLC, 701 Fifth Avenue, Suite 4800, Seattle, WA, 98104, US

(73) Assignee: EchoStar Technologies L.L.C., Englewood, CO (US)

(21) Appl. No.: 12/476,679

(22) Filed: Jun. 2, 2009

(51) Int. Cl. H04N 7/025

(52) U.S. Cl. 725/33

(57) ABSTRACT

National emergency alert test systems and methods are operable to test a national emergency alert system. An exemplary embodiment initiates a test of the national emergency alert message system, retrieves a national emergency alert test message from a memory, communicates the national emergency alert test message to a programming stream receive system via a local area network, interrupts programming provided in a plurality of program streams, and replaces the interrupted programming in the program streams with the retrieved national emergency alert test message.

### BACKGROUND

Media service providers provide a variety of media to their clients. Typically, each client receives a stream of media content, referred to herein as a transport channel, at their media device. The received transport channel typically comprises many different “channels” of program content. For example, a satellite-based or cable-based media provider may provide many “channels” of television programming and/or music programming to the client's media device, such as a set top box (STB) or other suitable receiver. The client then selects one of the “channels” of program content for presentation. The client's media device then parses out the selected “channel” of program content, and then presents it to the client. For example, the client may select a particular television “channel” to view a movie. The selected movie is then parsed out for the received stream of media content and presented to the client on their television (TV) and surround sound audio system.

During an emergency or the like, an emergency alert message may be communicated to the client. For example, an emergency alert message providing information about severe weather in a particular area may be provided to viewers in the affected localized area. Another example is an “Amber Alert” which notifies viewers of a missing and/or abducted child. Such emergency alert messages are typically “local” in nature. That is, they are not communicated out to viewers across the country.

In situations pertaining to a national emergency, viewers across the country should receive a national emergency alert message. For example, if the country is attacked, or if the country is subject to a large severe natural disaster, the country's government may wish to alert all of its citizens to the nature of the national emergency.

Prior art media systems are then required to communicate the national emergency alert message to all of their clients. When the media service provider provides many different types of media services to a very large number of customers located over a very wide geographic area, the task of providing a national emergency alert message to all of the clients is exceeding complex.

For example, a media service provider may provide television and movie channels (programming) to clients located across the country via a geographically dispersed media delivery system, such as a cable system or a satellite system. Individual “channels” of programming must be replaced with the national emergency alert message. Accordingly, the national emergency alert message is inserted into each individual channel of the transport channel, thereby replacing the current programming with the national emergency alert message. The process is similar to that of providing a local emergency alert message to selected programming channels. However, all programming channels must be modified to communicate the national emergency alert message.

In situations where a national emergency alert message must be provided across the country, there is a need to more efficiently and reliably interrupt the many different channels of programming with the national emergency alert message.

### SUMMARY

Systems and methods of testing a national emergency alert system are disclosed. An exemplary embodiment has an encoder configured to receive a national emergency alert message, and configured to format the received national emergency alert message for communication over a local area network (LAN) to a programming stream receive system and a memory configured to store a national emergency alert test message. The formatted national emergency alert message is communicated over the LAN to the programming stream receive system in response to receiving the national emergency alert message. The national emergency alert test message is communicated over the LAN to the programming stream receive system in response to initiating a test of the national emergency alert message. Then, a plurality of program streams receivable by the programming stream receive system are interrupted by and replaced with the communicated national emergency alert test message.

In accordance with further aspects, an exemplary embodiment initiates a test of the national emergency alert message system, retrieves the national emergency alert test message from the memory, communicates the national emergency alert test message to the programming stream receive system via the LAN, interrupts programming provided in a plurality of program streams, and replaces the interrupted programming in the program streams with the retrieved national emergency alert test message.

### BRIEF DESCRIPTION OF THE DRAWINGS

Preferred and alternative embodiments are described in detail below with reference to the following drawings:

FIG. 1 is a block diagram of an embodiment of the national emergency alert system; and

FIG. 2 is a block diagram of an alternative embodiment of the national emergency alert system.

### DETAILED DESCRIPTION

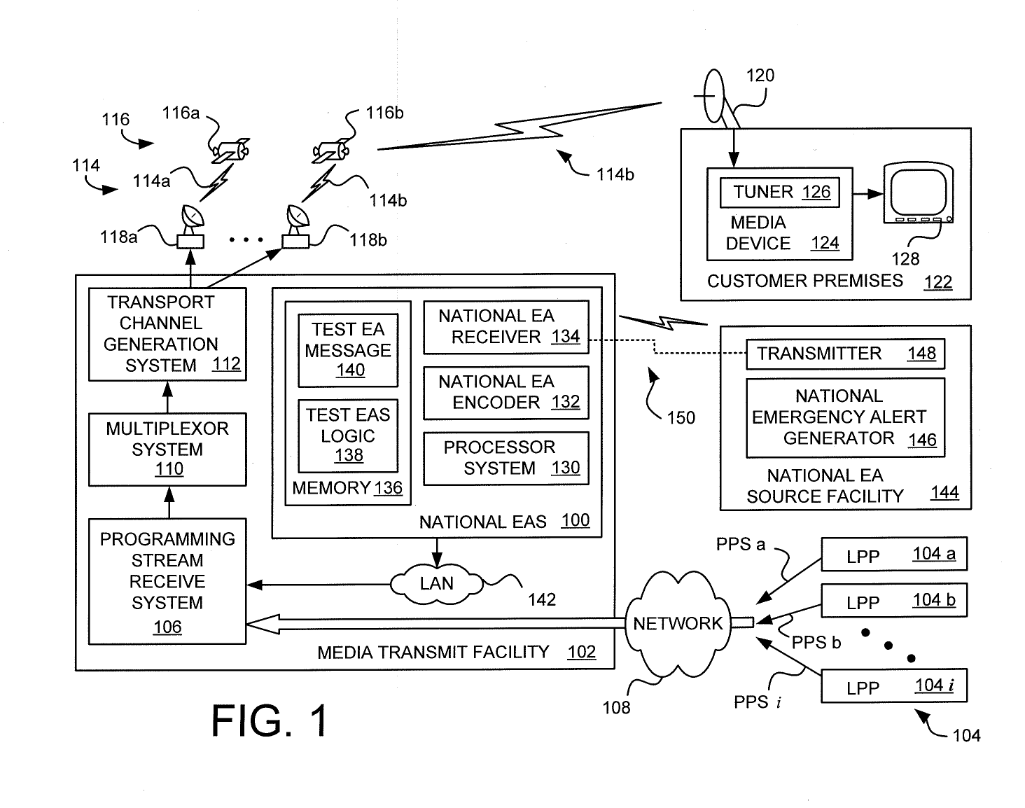

FIG. 1 is a block diagram of an embodiment of the national emergency alert system (EAS) 100. An exemplary embodiment of the national emergency alert system 100 is configured to communicate a national emergency alert message to viewers across the country. Further, a national emergency alert test message may be generated by the service provider to test the national emergency alert system 100.

The national emergency alert system 100 is part of a media system operated, in part, by a service provider that provides media to its clients. The media transmit facility 102 receives and bundles many programming streams (PS) generated by local program providers (LPPs) 104. The program streams are ultimately provided to the clients of the media service provider.

In an exemplary embodiment, the media transmit facility 102 establishes one or more communication links with the LPPs 104, via a distributed communication network 108. Non-limiting examples of the distributed communication network 108 include the Internet and/or the World Wide Web (WWW). In alternative embodiments, the distributed communication network 108 may include standard telephony systems, frame relay based systems, internet or intranet systems, Ethernet systems, cable systems, a radio frequency (RF) systems, cellular systems, or the like. Furthermore, the distributed communication network 108 may be a hybrid system comprised of one or more of the above-described systems.

In this exemplary embodiment, the media transmit facility 102 accesses a packetized programming stream (PPS) available at each of the LPPs 104. In embodiments where the media transmit facility 102 communicates to the LPPs 104 via the Internet, the accessing could be analogous to the means used by PC users who access the Internet for streaming video media content. Exemplary formats of such streaming video media include, but are not limited to, MPEG 2 and MPEG 4, which are video streams compressed under the MPEG (Moving Picture Experts Group) domain.

The plurality of packetized programming streams are received by the programming stream receive system 106. In an embodiment where programming stream receive system 106 receives the LPPs 104 via the Internet, the programming stream receive system 106 may be one or more multipoint master modems. The received packetized programming streams are communicated to the multiplexor system 110.

In some embodiments, the programming stream receive system 106 may receive digital or analog program streams from LPPs 104, or from an intermediary facility that bundles a plurality of local program streams into a transport channel that is communicated to the programming stream receive system 106. If the received programming streams are not already packetized, such as an analog programming stream, the programming stream receive system 106 is configured to packetize the received programming stream.

Selected packetized programming streams are multiplexed together (bundled) by the multiplexor system 110 into a digital signal. The digital signal is communicated to a transport channel generation system 112. The transport channel generation system 112 generates a transport channel signal 114 that is suitable for transmitting from the media transmit facilities 102 to the clients. The media transmit facility 102 may be interchangeably referred to as a head-end facility or the like.

In FIG. 1, the media transmit facility 102 is illustrated as a satellite uplink center that transmits the transport channel signal 114 as satellite-based wireless signals to a plurality of satellites 116 (a satellite media system). It is appreciated that the media transmit facility 102 may be transmitting to many different satellites 116 that are within its reception range. Accordingly, a plurality of different transport channel signals 114 may be tailored for the needs of particular geographic regions within reception range of a particular satellite 116. For example, assume that the satellite 116a is located over the first geographic region. Further, assume that the satellite 116b is located over a different geographic region. Thus, the media transmit facility 102 transmits a first transport channel signal 114a from an antenna 118a to the satellite 116a. A second transport channel signal 114b is transmitted from an antenna 118b to the satellite 116b.

In this exemplary embodiment, the received transport channel signal 114b is received by the antenna 120 at the customer premises 122. The antenna 120 may receive multiple transport channel signals 114 from multiple satellites. The media device 124, communicatively coupled to the antenna 120, receives the transport channel signals 114. A viewer selects one or more programs of interest embedded in the received transport channel signal 114b for viewing and/or recording. One or more tuners 126 in the media device 124 then tunes to the transport channel signal 114 having the selected program of interest. The media device 124 then parses out the selected “channel” of program content having the selected program of interest. The program of interest may then be recorded and/or communicated to a media presentation device, such as the illustrated television 128.

Other embodiments of the national emergency alert system 100 may be used by different types of media transmit facilities 102. For example, an alternative media transmit facility 102 may be a cable system distribution center that transmits wire-based transport channel signals 114 into a cable media system (not shown). Accordingly, clients connected to the cable distribution system receive programming via their home cable network. It is appreciated that a cable-based media transmit facility 102 may be transmitting to many different cable system sub-distribution facilities located in specific geographic locations so that a plurality of different transport channel signals 114 are tailored for the needs of particular geographic regions.

An exemplary embodiment of the national emergency alert system 100 resides at the media transmit facility 102. The national emergency alert system 100 comprises a processor system 130, a national emergency alert (EA) encoder 132, a national emergency alert (EA) receiver 134, and a memory 136. The memory 136 includes at least a first portion for the test emergency alert system (EAS) logic 138, and an optional portion for the test emergency alert (EA) message 140. The memory 136 may be an integrated component of the national emergency alert system 100, may be external to the national emergency alert system 100, may be a distributed memory system, or may be part of another system (not shown) that is accessible by the national emergency alert system 100. Here, the national emergency alert system 100 is communicatively coupled to the programming stream receive system 106 via a local area network (LAN) 142. In alternative embodiments, any suitable network 142 may be used to communicatively couple the national emergency alert system 100 to the programming stream receive system 106 (referred to herein as a LAN). Further, the LAN may be a single communication link (referred to herein as a LAN) between the national emergency alert system 100 and the programming stream receive system 106.

When a national emergency alert is authorized by a qualified authority, the national emergency alert is generated at the national emergency alert (EA) source facility 144. The national emergency alert source facility 144 has video and/or audio equipment that is used to create the national emergency alert. For example, a country's leader or authorized representative may give a speech that is recorded. The national emergency alert generator 146 generates a video-based national emergency alert. The national emergency alert may be generated in real time, or may be generated based upon a previous recording of the speech, and/or may be generated based upon a prepared message. The video-based national emergency alert may be provided in any suitable analog or digital medium format.

A transmitter 148 sends the video-based national emergency alert signal 150 to the national emergency alert receiver 134. The video-based national emergency alert may be sent wirelessly, or may be sent over a wire-based system. The transmitter 148 may alternatively reside remotely from the national emergency alert source facility 144.

Upon receipt of the video-based national emergency alert signal 150 by the national emergency alert receiver 134, the process of interrupting current programming with the national emergency alert is initiated. In an exemplary embodiment, the received national emergency alert is processed by the national emergency alert encoder 132 into a signal format that is receivable by the programming stream receive system 106. For example, but not limited to, the national emergency alert may be processed using the MPEG domain into a MPEG 2 and MPEG 4 video stream. The processed national emergency alert is communicated from the national emergency alert system 100 to the programming stream receive system 106 via the local area network 142.

Then, current programming is interrupted and is replaced with the received national emergency alert. The national emergency alert is multiplexed by the multiplexor system into a signal(s) that is then used to generate the transport channel signals 114. The transport channel signal 114 with the national emergency alert therein is then communicated to the clients of the service provider. The national emergency alert message is then displayed on the client's media presentation device, such as the television 128. Upon conclusion of the broadcast of the national emergency alert, normal programming (or delayed programming) is then resumed.

It is appreciated that the national emergency alert system 100 must be maintained in a highly reliable state so as to be immediately available in the event of a national emergency. Accordingly, from time to time, the national emergency alert system 100 is tested. At a selected test time, the national emergency alert system 100 conducts a national emergency alert test.

The national emergency alert test may be initiated automatically and/or manually. If initiated automatically, a prescheduled test time is stored in memory 136 or in another suitable memory medium. Alternatively, or additionally, a plurality of periodic test times, and/or a plurality of predefined times, may be stored so that multiple national emergency alert tests are performed. If the national emergency alert test is manually initiated, a user generated instruction is communicated to the processor system 130. User instructions may be generated using any suitable interface (not shown) that is in communication with the national emergency alert system 100. In some embodiments, authorized staff at the national emergency alert source facility 144 can initiate national emergency alert tests.

Upon initiation of a test of the national emergency alert system 100, processor system 130 retrieves and executes the test emergency alert system logic 138. The test emergency alert system logic 138 is configured to cause the national emergency alert system 100 to generate a national emergency alert test message that is inserted into the transport channel signals 114. That is, the plurality of program streams receivable by the programming stream receive system 106 are interrupted by and replaced with the communicated national emergency alert test message.

One or more national emergency alert test messages are stored in the test EA message 140 portion of memory 136. Upon initiation of a national emergency alert test, a selected national emergency alert test message is retrieved. Depending upon the particular nature of the test, a particular national emergency alert test message may be retrieved so that pertinent information describing the test is communicated to the clients of the service provider.

In some embodiments, the national emergency alert test message is sent to the national emergency alert encoder 132. The received national emergency alert test message is then processed by the national emergency alert encoder 132 into a packetized digital signal format that is receivable by the programming stream receive system 106 (thereby testing the national emergency alert encoder 132). The processed national emergency alert test message is then sent to the programming stream receive system 106 via the LAN 142.

In other embodiments, the retrieved national emergency alert test message is is pre-formatted into a packetized digital signal format so that the national emergency alert test message may be directly accessed by the programming stream receive system 106 via the LAN 142.

Similar to the communication of a bona fide national emergency alert, current programming is interrupted and is replaced with the national emergency alert test message. The national emergency alert test message is multiplexed by the multiplexor system 110 into a signal that is used to generate the transport channel signals 114 by the transport channel generation system 112. The generated transport channel signals 114 with the national emergency alert test message are then communicated to the clients of the service provider. The national emergency alert test message may then be displayed on the client's media presentation device, such as the television 128. Upon conclusion of the broadcast of the national emergency alert test message, normal programming (or delayed programming) is then resumed.

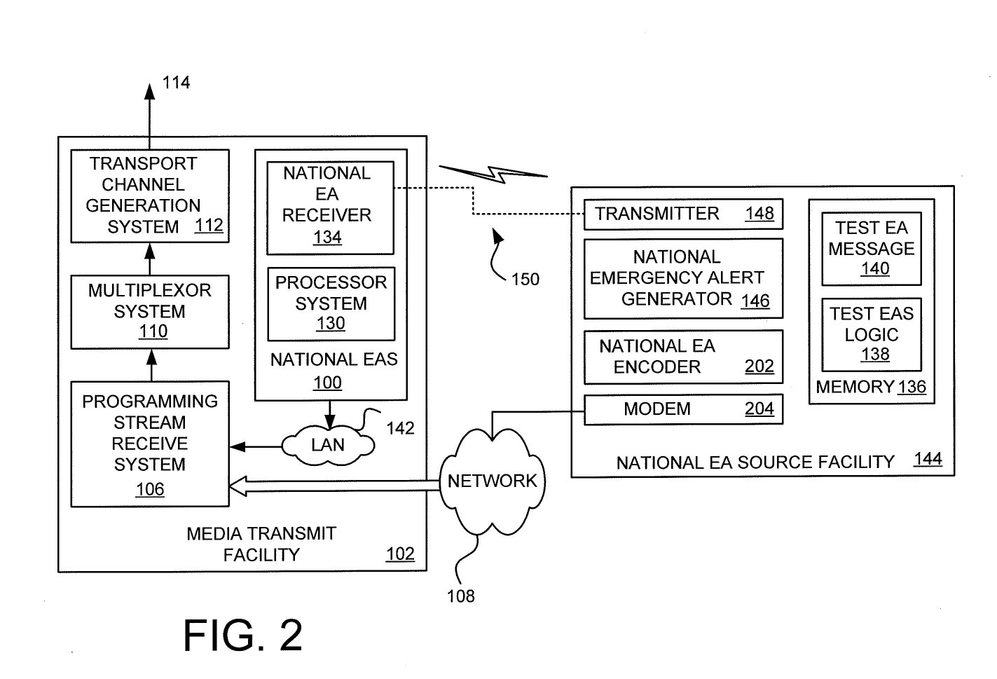

FIG. 2 is a block diagram of an alternative embodiment of the national emergency alert message system 100. With this exemplary embodiment, the national emergency alert message is formatted at the national emergency alert source facility 144 by the national emergency alert encoder 202. In some embodiments, the national emergency alert message is communicated to the national emergency alert receiver 134 via a suitable wireless signal, or via a suitable wire-based signal. Alternatively, the national emergency alert message may be communicated to the programming stream receive system 106 using a modem 204. The modem 204 provides a communication linking means, via the distributed communication network 108.

Further, in some embodiments, the national emergency alert test message is stored on the memory 136 at the national emergency alert source facility 144. The national emergency alert test message can then be generated and sent to the national emergency alert message system 100 from a remote source, such as the national emergency alert source facility 144. The received national emergency alert test message may be formatted, if necessary, and communicated to the programming stream receive system 106 via the LAN 142.

Testing may be performed for all of the program channels provided by the service provider such that the national emergency alert test message is concurrently communicated out to all clients. In other situations, selected program channels may be tested individually or as a group. For example, all of the programming channels in a single transport channel may be tested. Or, selected programs in a transport channel may be tested. Programming channels selected for testing may be based upon geographic regions or another criteria.

In the various embodiments, there are many different forms of transport video streaming that may be used for the national emergency alert message and the national emergency alert test message. Such examples include, but are not limited to, the MPEG format which is used to compress a streaming plurality of video images. Further, the packetized programming streams may use various protocols, such as a user datagram protocol (UDP), a Real-time Streaming Protocol (RTSP), a Real-time Transport Protocol (RTP), or a Real-time Transport Control Protocol (RTCP).

It should be emphasized that the above-described embodiments of the national emergency alert message system 100 are merely possible examples of implementations of the invention. Many variations and modifications may be made to the above-described embodiments. All such modifications and variations are intended to be included herein within the scope of this disclosure and protected by the following claims.

The embodiments of the invention in which an exclusive property or privilege is claimed are defined as follows:

1. A method for testing a national emergency alert message system, the method comprising:
initiating a test of the national emergency alert message system;
retrieving a national emergency alert test message from a memory;
communicating the national emergency alert test message to a programming stream receive system via a local area network (LAN);
interrupting programming provided in a plurality of program streams; and
replacing the interrupted programming in the program streams with the retrieved national emergency alert test message.

2. The method of claim 1, further comprising:
multiplexing the plurality of program streams with the national emergency alert message system into a transport channel signal; and
communicating the transport channel signal to a plurality of client media devices.

3. The method of claim 1, further comprising:
receiving the plurality of program streams at the programming stream receive system via a distributed communication network.

4. The method of claim 3, wherein the distributed communication network is the Internet.

5. The method of claim 1, further comprising:
communicating the retrieved national emergency alert test message to an encoder; and
processing the national emergency alert test message at the encoder into a packetized digital signal format configured for communication over the LAN.

6. The method of claim 1, wherein the retrieved national emergency alert test message stored in the memory is formatted as a packetized digital signal format configured for communication over the LAN.

7. The method of claim 1, wherein the retrieved national emergency alert test message is retrieved from a remote memory, and further comprising:
receiving the national emergency alert test message from the remote memory.

8. The method of claim 7, further comprising:
processing the received national emergency alert test message at an encoder into a packetized digital signal format configured for communication over the LAN.

9. The method of claim 1, further comprising:
selecting from the plurality of program streams a group of program streams for testing;
interrupting programming provided in the selected group of program streams; and
replacing the interrupted programming in the selected group of program streams with the retrieved national emergency alert test message.

10. The method of claim 1, further comprising:
communicating the national emergency alert test message to a plurality of clients via a satellite media system.

11. The method of claim 1, further comprising:
communicating the national emergency alert test message to a plurality of clients via a cable media system.

12. A national emergency alert test system, comprising:
a programming stream receive system configured to receive a plurality of program streams;
an encoder configured to receive a national emergency alert message, and configured to format the received national emergency alert message for communication over a local area network (LAN) to the programming stream receive system; and
a memory configured to store a national emergency alert test message, wherein the national emergency alert test message is communicated over the LAN to the programming stream receive system in response to initiating a test of the national emergency alert message,
wherein the formatted national emergency alert message is communicated over the LAN to the programming stream receive system in response to receiving the national emergency alert message, and
wherein the plurality of program streams receivable by the programming stream receive system are interrupted by and replaced with the communicated national emergency alert test message.

13. The national emergency alert test system of claim 12, wherein the memory is a remote memory, and further comprising:
a receiver coupled to the encoder, and configured to receive the national emergency alert test message from a transmitter residing in a remote source facility, and further configured to communicate the received national emergency alert test message to the encoder,
wherein the received national emergency alert test message is formatted for communication over the LAN by the encoder.

14. The national emergency alert test system of claim 12, wherein the national emergency alert test message is formatted for communication over the LAN.

15. The national emergency alert test system of claim 12, wherein the national emergency alert test message is communicated to the encoder and is formatted for communication over the LAN by the encoder.

16. A national emergency alert system, comprising:
a national emergency alert generator configured to generate a national emergency alert message;
a transmitter coupled to the national emergency alert generator and configured to communicate the national emergency alert message to a media transmit facility;
a receiver in the media transmit facility configured to receive the national emergency test message from the transmitter;
an encoder coupled to the receiver, configured to receive the national emergency alert message, and configured to format the received national emergency alert message for communication over a local area network (LAN);
a memory configured to store a national emergency alert test message; and
a programming stream receive system communicatively coupled to the LAN and configured to receive a plurality of program streams generated by local program providers, configured to receive the formatted national emergency alert message communicated over the LAN, and configured to receive the national emergency alert test message communicated over the LAN in response to initiating a test of the national emergency alert message,
wherein the plurality of program streams receivable by the programming stream receive system are interrupted by and replaced with the communicated national emergency alert test message.

17. The national emergency alert system of claim 16, further comprising:
a multiplexor system coupled to the programming stream receive system and configured to multiplex the programming streams with the national emergency alert test message therein into a signal; and
a transport channel generation system coupled to the multiplexor system, configured to receive the multiplexed signal, and configured to generate a transport channel.

18. The national emergency alert system of claim 17, further comprising:
a satellite media system coupled to the transport channel generation system and configured to communicate the transport channel with the national emergency alert test message therein to a plurality of clients.

19. The national emergency alert system of claim 16, wherein the national emergency alert test message is formatted for communication over the LAN.

20. The national emergency alert system of claim 16, wherein the national emergency alert test message is communicated to the encoder and is formatted for communication over the LAN by the encoder.
